(19) United States
(12) Patent Application Publication
(10) Pub. No.: US 2003/0018962 A1
(43) Pub. Date: Jan. 23, 2003

(54) System and method for accessing streaming data

(76) Inventors: Calvin White, Calgary (CA); Bertrand Michaud, Kanata (CA)

Correspondence Address: Patrick J. Fay, Esq., Fay Kaplun & Marcin, LLP, 100 Maiden Lane, 17th Floor, New York, NY, 10038, US

(21) Appl. No.: 09/904,882

(22) Filed: Jul. 12, 2001

(51) Int. Cl. G06F 9/44

(52) U.S. Cl. 717/166

(57) ABSTRACT

A system, comprising a stream source class loader retrieving streaming data to create a desired class object, an interface coupled to the stream source class loader and a plurality of streaming sources containing information including the location of data, wherein requests for data are communicated from the stream source class loader to the streaming sources via the interface and, data passes from the stream sources to the stream source class loader via the interface, the streaming sources searching the data locations for the requested data.

### BACKGROUND INFORMATION

Many devices such as personal digital assistants (“PDAs”) and other embedded devices contain applications and software that need to be loaded for the device to accomplish the functions requested by a user. This software may be loaded in various stages into, for example, a processor or temporary memory of the device. For example, software that provides basic services to the device may be loaded during the boot process so that these services are immediately available to the device. Whereas other software may be loaded on an as needed basis depending on requests made by the user. Individual software components may be loaded in whole or in part onto the device.

The information for loading software components or sub-components may be stored in various locations within the device or external to the device (e.g., on a network) and in various file formats. Application programs need reliable methods to load the software components from the various sources without burdening the resources of the device.

### SUMMARY OF THE INVENTION

A system, comprising a stream source class loader retrieving streaming data to create a desired class object, an interface coupled to the stream source class loader, and a plurality of streaming sources containing information including the location of data, wherein requests for data are communicated from the stream source class loader to the streaming sources via the interface and, data passes from the stream sources to the stream source class loader via the interface, the streaming sources searching the data locations for the requested data.

Furthermore, a method of loading a class object, comprising the steps of receiving a load request for the class object by a class loader, passing the load request to an interface module, wherein the interface module includes a method to retrieve streaming data associated with the class object, searching a data location with a stream source to find the data associated with the class object and streaming the data to the class loader.

### BRIEF DESCRIPTION OF DRAWINGS

FIG. 1 shows an exemplary block diagram showing the creation of a class object from a class using a class loader according to the present invention;

FIG. 2 shows a system implementing an exemplary stream source class loader according to the present invention;

FIG. 3 shows an exemplary process for fulfilling a request to load a class using the stream source class loader according to the present invention;

FIG. 4 shows an exemplary class loading scenario using a stream source class loader to load a class from zip file stream source according to the present invention.

### DETAILED DESCRIPTION

The present invention may be further understood with reference to the following description of preferred exemplary embodiments and the related appended drawings, wherein like elements are provided with the same reference numerals. It should be understood that the present invention may be implemented on any processor or controller based device such as PCs, servers, PDAs, embedded devices, etc. (and development platforms for the same), and the term devices will be used throughout this description to generically refer to all such devices. The exemplary embodiment of the present invention will be described with respect to the loading of Java® classes using a Java® class loader. However, those of skill in the art will understand that the present invention may be implemented in any system where data or code (e.g., byte code) needs to be loaded into the system and the source of the code may be implemented as a stream source.

FIG. 1 shows an exemplary block diagram illustrating the creation of class object 30 from class 10 using class loader 20. Class 10 is the basic unit of object orientation in Java and may be considered a blueprint for class object 30. Those skilled in the art will understand that although the present exemplary embodiment is described in regard to a single class, class loader and class object, the present invention will work equally well with software components including multiple classes and class objects in a software component. Class 10 allows the software developer to define the properties and methods that internally define class object 30, the application program interface (“APr”) methods that externally define class object 30 and the syntax necessary for handling other features of class object 30. Class 10 is generally stored in the form of byte code and may be stored on the device in, for example, a hard drive or flash memory, or may also be stored externally from the device, for example, on a network storage device accessible via a network (wireless or land-line). The byte code for class 10 may be located via a variety of sources, for example, the classpath, Uniform Resource Locators (“URLs”), and may be stored in a variety of contexts, such as zip files, databases, a Java Archive (“JAR”) file not on the classpath, etc. Class loader 20 is responsible for finding the byte code for class 10 when an execution module, for example, a Java Virtual Machine (“JVM”) needs to load class 10. As is well known, the JVM is a virtual computing environment implemented in software on top of the device hardware and operating system to run compiled Java programs. Class loader 20 may itself be considered an object that can be managed by the JVM. When class loader 20 finds class 10, it reads in the byte code for class 10 to create or instantiate class object 30 which is used by the JVM to run the program. As described above, class 10 functions as a blueprint for class object 30 which becomes the actual object which is stored in the device memory. Class object 30 may then utilize the methods and APIs defined by class 10.

Class loader 20 may be a primordial or default class loader generally responsible for loading essential functions into the JVM. The primordial class loader may also load classes from a classpath defined by the user or developer. The primordial class loader is limited in this manner for a variety of reasons including, for example, security issues relating to loading classes from untrusted sources. However, most developers and/or users find this too limiting and want to load, during runtime, new classes that are not on the predefined classpath. As described above, class 10 may be stored in a variety of sources/locations in addition to the classpath, e.g., URLs, zip files, databases, JAR files, etc. To accomplish this goal, developers write their own class loaders which may be referred to as custom class loaders. In the example described above, class loader 20 may be a primordial class loader or a custom class loader. Some examples of custom class loaders include, applet class loaders, secure class loaders, remote method invocation (“RMI”) class loaders, etc. These custom class loaders may search, find and load classes from virtually any location or type of file. For example, the classes may be located in a database on the device itself or may be located via a URL link over a network. A custom class loader may be implemented for each type of data source, e.g., URLs, zip files, databases, JAR files, etc. Thus, a single software component may contain multiple custom class loaders resulting in the allocation of a large portion of available system memory (e.g., random access memory (“RAM”)) to class loaders.

Another method of loading the class may be by implementing a single custom class loader that is a URL class loader. In this case, the class loader provides a level of source abstraction, meaning that the location or source of the class is transparent to the application program. However, there may be a performance penalty related to the handling of URLs because they may be quite long and become nested to multiple levels. Additionally, system resources need to be allocated to convert other sources (e.g., databases files, etc.) to URLs that are usable by the system.

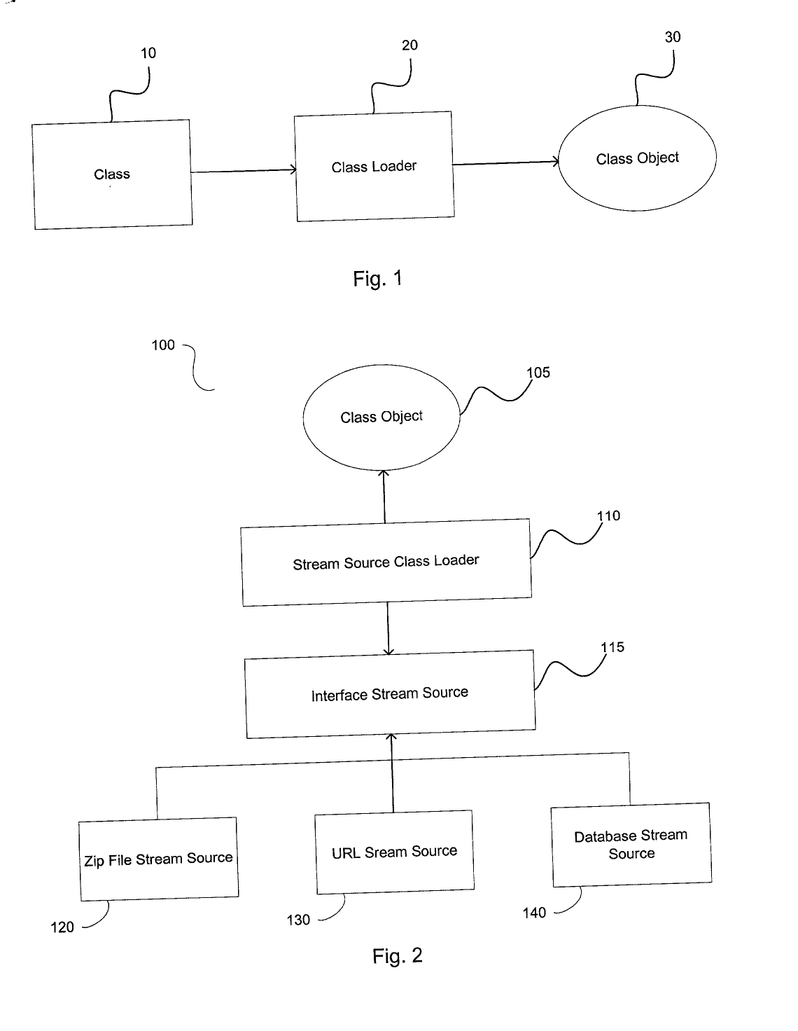

FIG. 2 shows a system 100 implementing an exemplary stream source class loader 110 according to the present invention. Stream source class loader 110 is a custom class loader for loading classes from various sources. In exemplary system 100, three exemplary sources of class byte code are shown, zip file stream source 120, URL stream source 130 and database stream source 140. These sources will be described in greater detail below. As described above, a class loader (e.g., stream source class loader 110) finds the requested class information and reads in the byte code for the class to create or instantiate class object 105. Those skilled in the art will understand that sources 120-140 may contain multiple classes and that stream source class loader 110 may load any of these multiple classes to instantiate multiple class objects 105. In system 100, a single class loader, stream source class loader 110, loads all classes from sources 120-140.

Stream sources 120-140 provide streaming data as a sequence of bytes. Thus, the byte code of any classes may be streamed out of the stream source (e.g., stream sources 120-140) as a sequence of bytes. A stream source may be implemented for each source location for the different types of sources in a given system. In exemplary system 100, there are three sources of class information for which a stream source is implemented (e.g., zip file stream source 120, URL stream source 130 and database stream source 140). If a system were to have other sources such as JAR files or Java Database Connectivity™ (“JDBC”) files, additional stream sources for these sources may be included by a developer. A stream source may be customized by the developer to load data in an efficient manner for its source. For example, zip file stream source 120 may be customized to remain open with the class information extracted once zip file stream source 120 is opened for the first time in a particular session of the device. This manner of accessing zip file stream source 120 may be more efficient than opening zip file stream source 120 when it is the source for a requested class and closing zip file stream source 120 immediately after the request has been fulfilled. A similar customization may be implemented for database stream source 140.

The exemplary embodiment of the present invention allows the single stream source class loader 110 to load classes from any one of stream sources 120-140 without the need to implement additional custom class loaders. In this manner, the class information remains abstracted (or transparent) to the application program, but does not burden the device resources, for example, device memory, with the requirement of incorporating and supporting multiple class loaders for multiple sources of class information. Development costs may also be reduced since there is only one custom class loader that needs to be developed, tested and maintained for the system. Additionally, stream source class loader 110 does not result in the performance penalty that may be associated with URL handling which allows for faster access to the class byte data than implementing a URL class loader.

Stream source class loader 110 uses interface stream source 115 as an interface to allow stream source class loader 110 to access the class byte code as streaming data available via stream sources 120-140. Interface stream source 115 may contain multiple methods for accessing stream sources 120-140. For example, interface stream source 115 may contain an open method to open sources 120-140, a read method to read the byte data from sources 120-140, a close method to close sources 120-140, a bitrate method to return the bitrate of the source it is accessing, etc. Those of skill in the art will understand that interface stream source 115 is a conventional Java® interface and that a developer may include any number of standard or custom methods or functions in interface stream source 115. However, the most efficient interface will implement the fewest number of methods because each additional method will increase the memory footprint of the interface. Thus, an efficient interface may only include a single method to get the input stream. Also, if the present invention is implemented on a system that does not support Java®, the developer may include analogous methods to open and retrieve information from a stream source. Stream source class loader 110 receives the streaming byte data for the requested class using the methods of interface stream source 115. After stream source class loader 110 has received the byte data, it may read in the byte code for the requested class and instantiate class object 105.

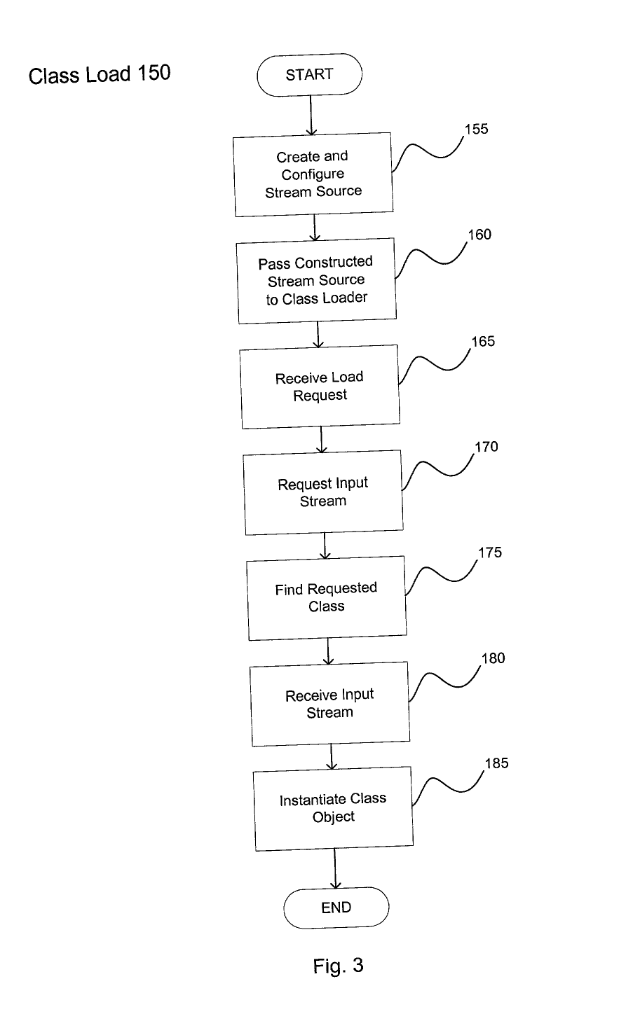

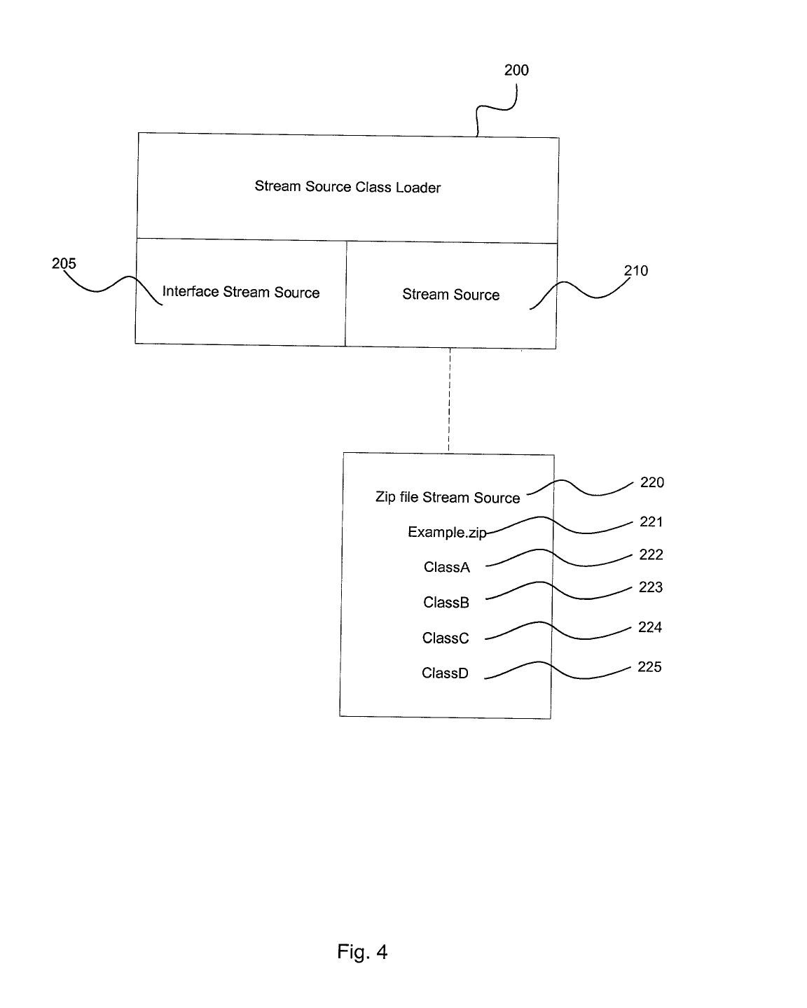

FIG. 3 shows an exemplary class load process 150 for fulfilling a request to load a class using a stream source class loader. Exemplary process 150 will be described with reference to FIG. 4 which shows an exemplary class loading scenario using stream source class loader 200 to load a class from zip file stream source 220. In FIG. 4, stream source class loader 200 includes interface stream source 205 which, as described above, may include methods to access data in a stream source and an instance of a stream source 210. At compile time, the instance of stream source 210 is included in stream source class loader 200, but the actual desired stream source (e.g., zip file stream source, database stream source, etc.) may be determined on a dynamic basis at runtime. In step 155, the application program creates (and configures) the stream source 210 that the steam source class loader 200 will use during runtime. When the application program creates the stream source class loader 200 it passes this constructed and configured stream source 210 to the stream source class loader 200 (step 160). From that point on, that class loader object will always use that same stream source 210. The following is exemplary pseudo-code for implementing such a solution as described in steps 155-160:

StreamSource zipStreamSource=new ZipStreamSource(zipFileName);

ClassLoader newClassLoader=new StreamSourceClassLoader(zipStreamSource);

In this case, the stream source class loader 200 is configured to use a single stream source 210 to retrieve byte data. An array of stream sources 210 may also be passed in to configure the stream source class loader 200 to use multiple stream sources 210. The instance of stream source 210 in stream source class loader 200 may be considered a slot or a place holder that is compiled into stream source class loader 200 so that an actual stream source may be plugged into stream source class loader 200 by an application program. For example, an application program may create and configure zip file stream source 220 and dynamically insert zip file stream source 220 into the stream source 210 instance that was compiled with stream source class loader 200. Zip file stream source 220 may then be opened by stream source class loader 200 using the methods of interface stream source 205. Those of skill in the art will understand that the steps described for process 150 occur during runtime of the device, whereas the preparation of stream source class loader 200 (e.g., instantiating stream source 210 and the methods of interface stream source 205) may occur at development and compile time.

Referring back to FIG. 3, in step 165, stream source class loader 200 receives a load request from the application program currently running on the device. For example, stream source class loader 200 may receive a request in the form of loadClass(classA) which indicates that the application program desires that classA 222 should be loaded. The process then continues to step 165 where the stream source class loader 200 passes the requested class to the stream source 210. In the case where the stream source class loader 200 is configured to use multiple stream sources (e.g., by passing stream source class loader 200 an array of stream sources), the request may be passed to each of the multiple stream sources. Those skilled in the art will understand that this process may be made more efficient by directing the stream source class loader 200 to query the available stream sources 210 beginning with a most likely stream source 210 and proceeding sequentially in descending order of likelihood through the rest of the stream sources 210.

The process then continues to step 170 where stream source 210 (e.g., zip file stream source 220) searches for the requested class. For example, zip file stream source 220 may be able to load data from a file named example.zip 221 which contains a series of compressed classes 222-225. Stream source class loader 200 may contain a method which accesses example.zip 221 and extracts each of the compressed files 222-225. The stream source class loader 200 then contacts the stream sources 210 which search through their respective classes (e.g., classA 222, classB 223, classC 224 and classD 225), until the requested class is found. After the requested class has been found, the methods of stream source 210 may be used to stream the byte code or data to stream source class loader 200 in step 180. When stream source class loader 200 has received the byte code for the requested class, it can instantiate a class object in step 185 using the information from the requested class. The following is exemplary pseudo code illustrating the above operation:

class StreamSourceClassLoader {

StreamSourceClassLoader(streamSource) {

myStreamSource = streamSource;

}
loadClass(className) {

InputStream stream = myStreamSource.getInputStream(className);
if (stream != null) {

return loadClassFromStream(stream);

} else {

// failed to find class
return null;

}

}

}
class exampleStreamSource implements StreamSource {

getInputStream(fileName) {

Handle handle = findFile(fileName);
if (handle == null) {

// couldn't find file
return null;

} else {

InputStream stream = getDataStream(handle);
return stream;
}

}

}

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A system, comprising:
a stream source class loader retrieving streaming data to create a desired class object;
an interface coupled to the stream source class loader, and
a plurality of streaming sources containing information including the location of data, wherein requests for data are communicated from the stream source class loader to the streaming sources via the interface and, data passes from the stream sources to the stream source class loader via the interface, the streaming sources searching the data locations for the requested data.

2. The system according to claim 1, wherein the class object is a Java class object.

3. The system according to claim 1, wherein the plurality of streaming sources includes one of a zip file stream source, a database stream source and a uniform resource locator stream source.

4. A class loader, comprising:
a receiving module to receive a request for a desired class object;
a stream source module containing information including the location of data which may be streamed to the class loader;
an interface module which receives requests for data from the receiving module and retrieves the streaming data from the stream source module, wherein the stream source module searches the data locations for the requested data; and
an instantiating module to receive the streaming data from the interface module and instantiate the class object.

5. The class loader according to claim 4, wherein the stream source module includes a streaming source set by an application program.

6. The class loader according to claim 4, wherein the stream source module includes a plurality of streaming sources, wherein the stream source module searches each of the streaming sources to locate the desired data.

7. The class loader according to claim 6, wherein the stream source module searches each of the streaming sources beginning with a most likely streaming source and proceeding sequentially in descending order of likelihood through the remaining streaming sources.

8. A method of loading a class object, comprising the steps of:
receiving a load request for the class object by a class loader;
passing the load request to an interface module, wherein the interface module includes a method to retrieve streaming data associated with the class object;
searching a data location with a stream source to find the data associated with the class object; and
streaming the data to the class loader.

9. The method according to claim 8, further comprising the step of:
instantiating the class object using the streamed data.

10. The method according to claim 8, further comprising the step of:
configuring the stream source including the location of the data for the class object.

11. The method of claim 8, wherein the data locations include one of zip files, databases and uniform resource locators.

12. The method of claim 8, wherein, if the data associated with the class object is not found, an error is returned.
